(19) United States
(12) Patent Application Publication
(10) Pub. No.: US 2016/0201249 A1
(43) Pub. Date: Jul. 14, 2016

(54) WASHING MACHINE WITH CIRCULATED WATER TREATMENT FUNCTION AND CONTROL METHOD THEREFOR

(71) Applicants: HAIER GROUP CORPORATION, Qingdao (CN); QINGDAO HAIER WASHING MACHINE CO., LTD., Qingdao (CN)

(72) Inventors: Sheng XU, Qingdao (CN); Jinzhu DENG, Qingdao (CN)

(21) Appl. No.: 15/043,879

(22) Filed: Feb. 15, 2016

Related U.S. Application Data
(63) Continuation of application No. PCT/CN2013/089803, filed on Dec. 18, 2013.

(30) Foreign Application Priority Data
Aug. 15, 2013 (CN) 201310356428.5

(51) Int. Cl. D06F 39/08; C02F 1/52; D06F 39/10

(52) U.S. Cl. CPC D06F 39/083; D06F 39/10; C02F 1/52; C02F 2307/12; C02F 2103/002

(57) ABSTRACT

A washing machine includes a water containing drum, a washing structure arranged inside the water containing drum and a circulated water treatment device arranged under the water containing drum. The circulated water treatment device includes a flocculation treatment unit and a filtering unit. The flocculation treatment unit includes a flocculation container connected to the water containing drum and a flocculation agent dosing device for dosing a flocculation agent into the flocculation container, where water is discharged from the water containing drum to the flocculation container for flocculation treatment. The filtering unit includes a filtering container and a filter net arranged inside the filtering container, the filtering container is in communication with the flocculation container and the water containing drum, respectively, for filtering the water having been flocculation-treated in the flocculation container and discharging same again into the water containing drum for reuse.

### CROSS-REFERENCE TO RELATED APPLICATIONS

This application is a continuation application of International Patent Application No. PCT/CN2013/089803, filed Dec. 18, 2013, which itself claims the priority to Chinese Patent Application No. 201310356428.5, filed Aug. 15, 2013 in the State Intellectual Property Office of P.R. China, which are hereby incorporated herein in their entireties by reference.

### FIELD OF THE INVENTION

The present invention relates generally to the field of washing machines, and more particularly to a circulated water-saving washing machine, and particularly to a washing machine with a circulated water treatment function and a control method therefor.

### BACKGROUND OF THE INVENTION

With improvement of people's living standard, the washing machine has become one of main household appliances in people's daily life, the washing process of the washing machine mainly includes washing, rinsing and spin-dry stages, in the washing stage, water and detergent flood in the washing machine to wash clothes, after the washing machine enters the rinsing stage, in order to rinse stains and residual detergents, it is necessary to take in more water or perform more rinsing times to rinse the clothes, this will definitely consume a large number of water resources, even if it is a water-saving roller washing machine, in order to clean the clothes, the clothes needs to be rinsed at least twice, and such a process will at least consume more than 30 L of running water. Sometimes, there are fewer stains on the clothes or fewer detergents are dispensed into, the clothes may be clean after twice-rinsing, however, as the user selects 3-times rinsing, it will definitely cause a waste of water resources, for example, generally, during twice-rinsing of a 6 Kg full automatic washing machine, about 100 L of water is basically used. How to save water and electricity while the clothes is cleaned is always one of the focuses of consumers.

So far, a water purification and recycling device used in conjunction with a household washing machine has not yet appeared, even if the so-called washing machine with a water saving function, a water storage tank is generally mounted to a side position of the washing position, and a water pump is used for injecting water and draining water, which generally can inject water once and rinse the clothes three times, to play a role of saving water. However, the water after washing cannot be stored; at the same time, the structure of the washing machine is complicated and large, which is not conductive to transportation, recycling and so on. Due to limitations in the volume, structure, flexibility and other aspects, full play of the original function of the washing machine and the function of the water saving tank is affected. On the basis of the existing washing modes, in order to better save the water resources, many manufacturers have invested a lot of research and development.

The existing washing machine has a circulated water function, which merely plays a role of filtering threads, washing evenly or adding ozone, heavy metal ion sterilization and the like. The amount of water consumed cannot be improved, and the cleaning is not improved at all.

Regarding recycling of the laundry water, upon reference, for example, as disclosed in Chinese Patent Application No. 200810072420.5, entitled “water saving device for recycled water of washing machine”, the laundry water is dispensed into a water drum for purification treatment. In the invention, the first-pass laundry water is directly drained away without purification, and the second-pass and third-pass rinse water, after purification treatment, is left for use in next washing.

In the above technology, the “circulated water technology” is used after the rinse water is purified, the technology cannot recycle the first-pass laundry water (rough cleaning water), and the purified water should be left for use in next washing, but cannot be used in the current washing.

In view of the foregoing, the present invention is proposed.

### SUMMARY OF THE INVENTION

A technical problem to be solved in the present invention is to provide a washing machine having a circulated water treatment function that filters wash and rinse water by using flocculation, so as to overcome the shortcomings of the prior art.

Another objective of the present invention is to provide a control method of providing the water-saving washing machine.

To solve the foregoing technical problem, the basic concept of the technical solution adopted by the present invention is: a washing machine having a circulated water treatment function, including a water containing drum, a clothes washing structure disposed in the water containing drum and a circulated water treatment device disposed below the water containing drum, wherein the circulated water treatment device includes a flocculation treatment unit and a filter unit,

the flocculation treatment unit includes a flocculation container in communication with the water containing drum and a flocculant dispenser to which a flocculant is dispensed into the flocculation container, and the water containing drum drains water into the flocculation container for flocculation treatment; and

the filter unit includes a filter container and a strainer disposed in the filter container, the filter container is in communication with the flocculation container and the water containing drum respectively, and the water after flocculation treatment in the flocculation container is filtered and then re-drained into the water containing drum for reuse.

Further, the circulated water treatment device further includes a circulated water structure that drains the water after flocculation and filtering into the water containing drum for recycling, and a drainage structure that drains the water outside the washing machine at the end of work.

Further, a lower portion of the flocculation container and a lower portion of the filter container control connection/disconnection between the two containers through an on-off control structure, an upper portion of the flocculation container is in communication with a water outlet at the bottom of the water containing drum through a water guide pipe, and the water guide pipe is provided with an outlet control valve.

Further, the flocculation container and the filter container are separately arranged side by side below the water containing drum, and are communicated through a connecting pipe, and the connecting pipe is provided with a stop valve to control connection/disconnection between the two containers; or, the filter container is disposed inside the flocculation container, a chamber between the filter container and the flocculation container is used for flocculating water, a lower portion of the filter container is provided with a port, and the port is provided with an on-off control structure that controls connection/disconnection between the two containers.

Further, the bottom of the flocculation container is provided with a drainage structure that drains water outside the washing machine, including a flocculation container drain outlet, a drain pipe and a drain valve in communication with the drain outlet.

Further, the filter container is provided with a circulated water structure that drains filtered water into the water containing drum, including a filter container circulated water outlet, a circulating pump and a circulating pipe, the circulating pipe is in communication with the water containing drum, the strainer divides the interior of the filter container into two parts, the first part is in communication with the flocculation container, and the second part is in communication with the water containing drum through the circulated water structure.

Further, the flocculation container is disposed above the filter container, the bottom of the flocculation container is in communication with the upper portion of the filter container through a connecting pipe, the connecting pipe is provided with a stop valve, the upper portion of the flocculation container is in communication with a water outlet at the bottom of the water containing drum through a water guide pipe, and the water guide pipe is provided with an outlet control valve.

Further, the bottom of the filter container is provided with a drainage structure that drains water outside the washing machine and a circulated water structure that drains filtered water into the water containing drum, the strainer divides the interior of the filter container into two parts, the first part is in communication with the connecting pipe and the drainage structure respectively, and the second part is in communication with the water containing drum through the circulated water structure.

Further, the flocculation treatment unit further includes a flocculation stirring structure that mainly consists of a stirring motor, a stirring shaft and a stirring impeller, the stirring motor is disposed outside the flocculation container, the stirring shaft extends to the interior of the flocculation container from the stirring motor, and the stirring impeller is disposed on the stirring shaft inside the flocculation container.

Further, the strainer is a tubular structure and rotatably disposed in the filter container, one end is driven and connected through a cleaning motor, and the other drains the filtered water into the water containing drum through a rotating joint.

A control method of the washing machine of the present invention is: after washing ends, water is drained to the circulated water treatment device, passes through the flocculation treatment unit for flocculation treatment and the filter unit for filtering in sequence, and then is drained into the water containing drum for rinsing, the water treatment process is circulated until the rinsing ends, and the water is drained into the circulated water treatment device to be cleaned through the flocculation treatment unit and the filter unit and is finally drained out.

Further, the washing machine of the present invention further includes an automatic detergent dispensing device, the automatic detergent dispensing device is the existing technology, preferably a structure that pumps and dispenses detergent by using intake negative pressure; the flocculant dispenser of the present invention is an automatic dispensing structure, and according to wash water quantity and the turbidity degree of wash/rinse water, a corresponding proportion of flocculant is automatically dispensed during each flocculation treatment; preferably, the flocculant is flaky, and it is feasible to employ an automatic dispensing structure of the existing flaky flocculant.

Further, in the present invention, whether flocculation treatment is required is judged according to the turbidity degree of the wash water detected after washing, when the turbidity degree is higher, the wash water can be directly drained out completely, clean water floods in again for rinsing, and after first rinsing, flocculation circulation rinsing is carried out with water; or a certain proportion of wash water is drained out according to the range of the turbidity degree, then tap water floods in to reduce the turbidity degree, and flocculation circulation rinsing is carried out with water.

After the foregoing technical solution is adopted, the present invention has the following beneficial effects compared with the prior art.

1. After the washing ends, the water in the water containing drum is clean water, and the clothes does not have the problem that the washing powder remains or the clothes is not cleaned, which is conductive to user's health.

2. According to the present invention, the whole washing process can be completed only with one-time intake, which saves water resources to the greatest extent while the washing efficiency is not affected.

3. As the water of the washing machine drained out after washing basically does not contain the washing powder or detergent, the pollution to the environment can be reduced.

### BRIEF DESCRIPTION OF THE DRAWINGS

FIG. 1 and FIG. 2 are schematic structural diagrams of the washing machine according to a first embodiment of the present invention.

FIG. 3 and FIG. 4 are schematic structural diagrams of the washing machine according to a second embodiment of the present invention.

FIG. 5 and FIG. 6 are schematic structural diagrams of the washing machine according to a third embodiment of the present invention.

FIG. 7 is a schematic structural diagram of the washing machine according to a fourth embodiment and a fifth embodiment of the present invention.

FIG. 8 is a schematic structural diagram of the washing machine according to the fifth embodiment of the present invention.

### DETAILED DESCRIPTION OF THE INVENTION

Specific embodiments of the present invention are further described below in detail with reference to the accompanying drawings.

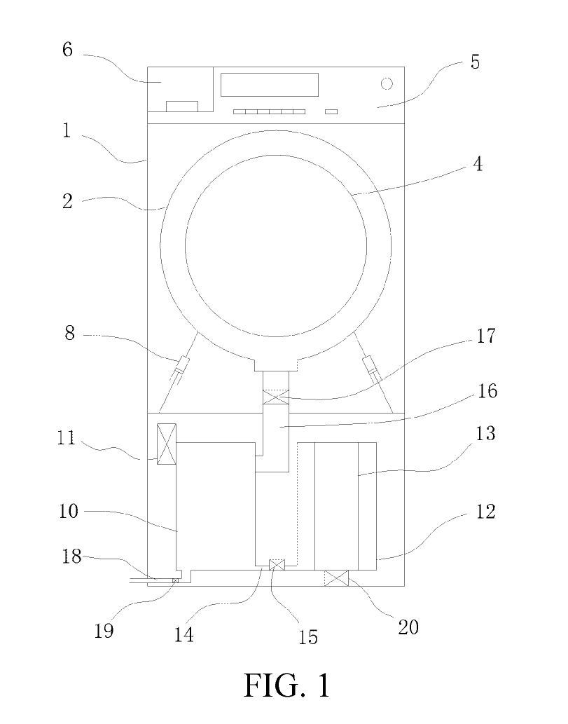

As shown in FIG. 1 to FIG. 8, according to the washing machine of the present invention, an upper portion is the existing washing machine structure, a lower portion is a circulated water treatment device, the washing machine includes a housing 1, an outer drum 2 disposed in the housing 1, an inner drum disposed in the outer drum 2, a door body 4, a control panel 5, an intake system 6 and a drive motor 7, the bottom and an upper portion of the outer drum 2 are connected with the frame of the housing respectively through a damper 8 and a suspension spring 9, and the intake system 6 includes an intake structure and an automatic detergent dispensing device. The outer drum 2 is a water containing drum, and the inner drum 3 disposed in the outer drum is a washing structure.

The circulated water treatment device of the present invention includes a flocculation treatment unit and a filter unit, wherein the flocculation treatment unit includes a flocculation container 10 in communication with the outer drum and a flocculant dispenser 11 to which a flocculant is dispensed into the flocculation container 10, and the outer drum 2 drains water into the flocculation container 10 for flocculation treatment; and the filter unit includes a filter container 12 and a strainer 13 disposed in the filter container 12, the filter container 12 is in communication with the flocculation container 10 and the outer drum 2 respectively, and the water after flocculation treatment in the flocculation container 10 is filtered and then re-drained into the outer drum 2 for reuse.

Further, the circulated water treatment device further includes a circulated water structure that drains the water after flocculation and filtering into the outer drum 2 for recycling, and a drainage structure that drains the water outside the washing machine at the end of work. After a certain number of times of flocculation and filtering circulation are carried out to complete the final rinsing, the clean water in the outer drum is drained to the circulated water treatment device for re-cleaning the flocculation container and the strainer, and then the water after cleaning is drained out.

### Embodiment 1

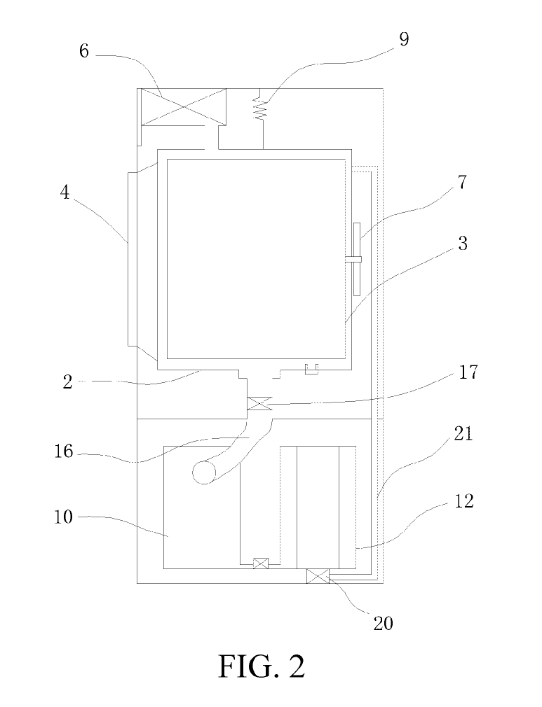

As shown in FIG. 1 and FIG. 2, the flocculation container 10 and the filter container 12 of this embodiment are arranged side by side below the outer drum 2, a lower portion of the flocculation container 10 and a lower portion of the filter container 12 through a connecting pipe 14, and the connecting pipe 14 is provided with a stop valve 15 to control connection/disconnection between the two containers. An upper portion of the flocculation container 10 is in communication with a water outlet at the bottom of the outer drum 2 through a water guide pipe 16, and the water guide pipe 16 is provided with an outlet control valve 17. The bottom of the flocculation container 10 is provided with a drainage structure that drains water outside the washing machine, including a flocculation container drain outlet, a drain pipe 18 and a drain valve 19 in communication with the drain outlet.

Further, the filter container 12 is provided with a circulated water structure that drains filtered water into the outer drum 2, including a filter container circulated water outlet, a circulating pump 20 and a circulating pipe 21, the circulating pipe 21 is in communication with the outer drum 2, the strainer 13 divides the interior of the filter container 12 into two parts, the first part is in communication with the flocculation container 10 through the connecting pipe 14, and the second part is in communication with the outer drum 2 through the circulated water structure.

### Embodiment 2

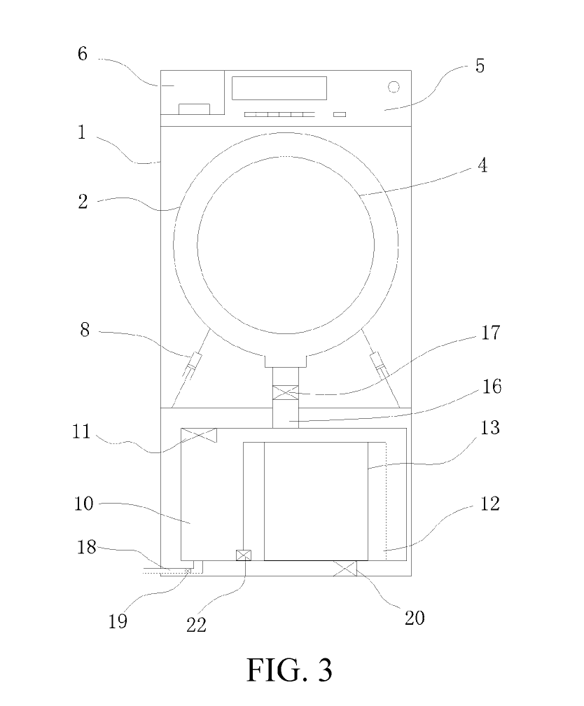

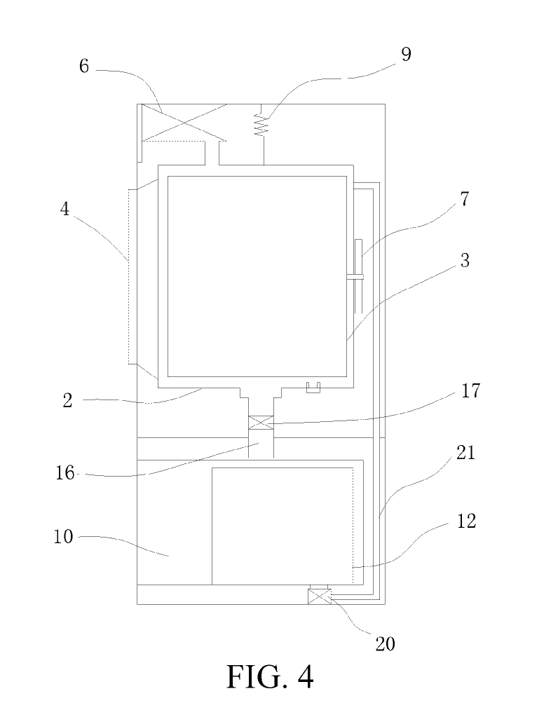

As shown in FIG. 3 and FIG. 4, this embodiment is different the first embodiment in that: the filter container 12 is disposed inside the flocculation container 10, a chamber between the filter container 12 and the flocculation container 10 is used for flocculating water, a lower portion of the filter container 12 is provided with a port, and the port is provided with an on-off control structure 22 that controls connection/disconnection between the two containers.

### Embodiment 3

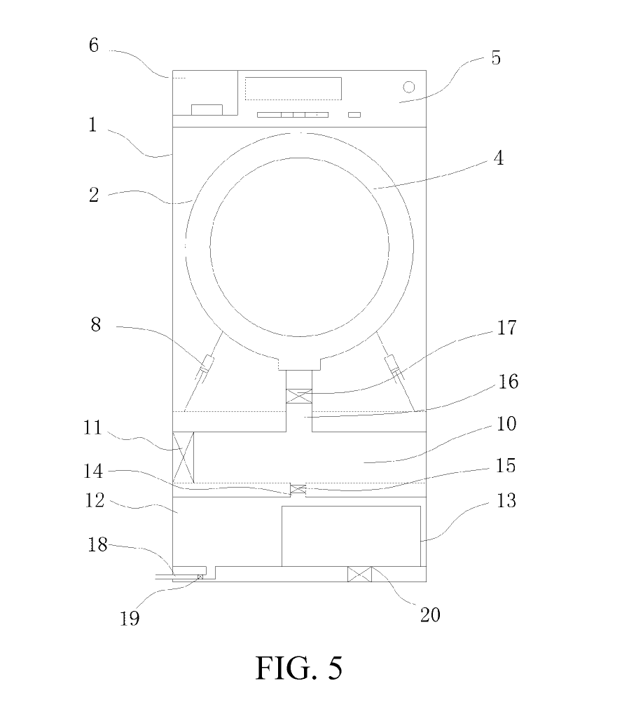

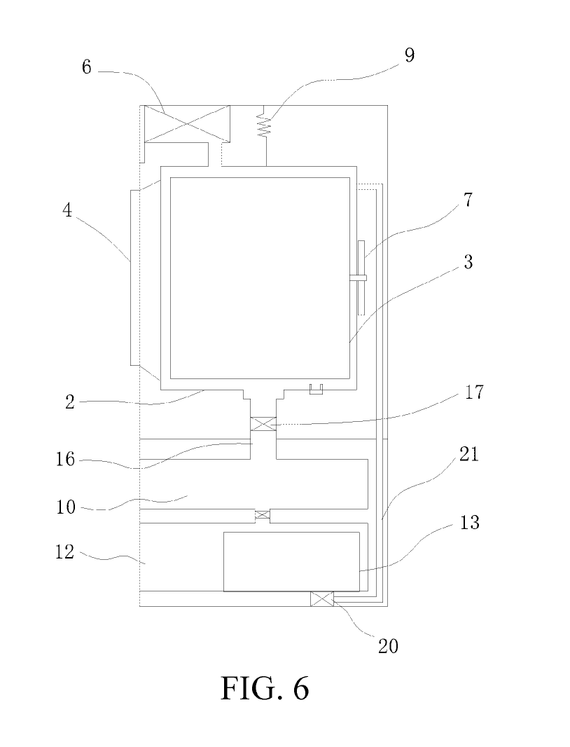

As shown in FIG. 5 and FIG. 6, the flocculation container 10 of this embodiment is disposed above the filter container 12, the bottom of the flocculation container 10 is in communication with the upper portion of the filter container 12 through a connecting pipe 14, the connecting pipe 14 is provided with a stop valve 15, the upper portion of the flocculation container 10 is in communication with a water outlet at the bottom of the outer drum through a water guide pipe 16, and the water guide pipe 16 is provided with an outlet control valve 17.

The bottom of the filter container 12 is provided with a drainage structure that drains water outside the washing machine and a circulated water structure that drains filtered water into the outer drum 2, the strainer 13 divides the interior of the filter container 12 into two parts, the first part is in communication with the connecting pipe 14 and the drainage structure respectively, and the second part is in communication with the outer drum 2 through the circulated water structure.

### Embodiment 4

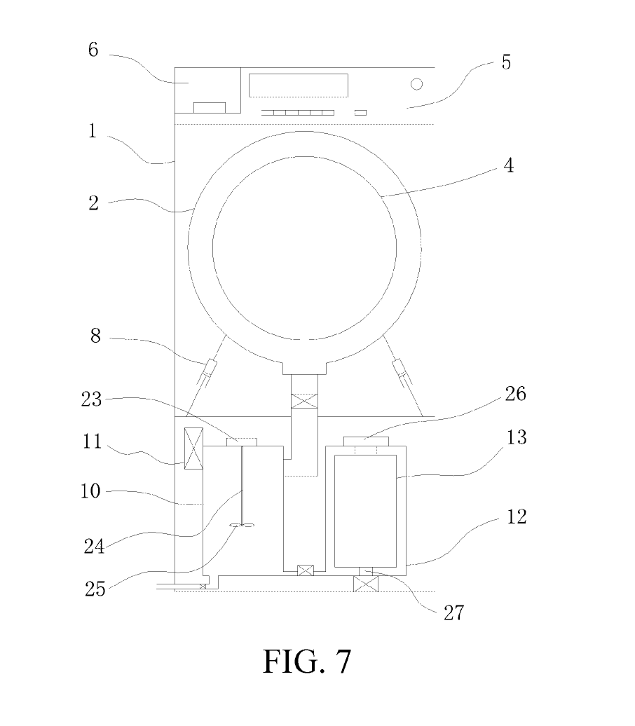

As shown in FIG. 7, this embodiment makes further improvement on the basis of the above embodiment: the flocculation treatment unit further includes a flocculation stirring structure that mainly consists of a stirring motor 23, a stirring shaft 24 and a stirring impeller 25, the stirring motor 23 is disposed outside the flocculation container 10, the stirring shaft 24 extends to the interior of the flocculation container 10 from the stirring motor 23, and the stirring impeller 25 is disposed on the stirring shaft 24 inside the flocculation container 10.

### Embodiment 5

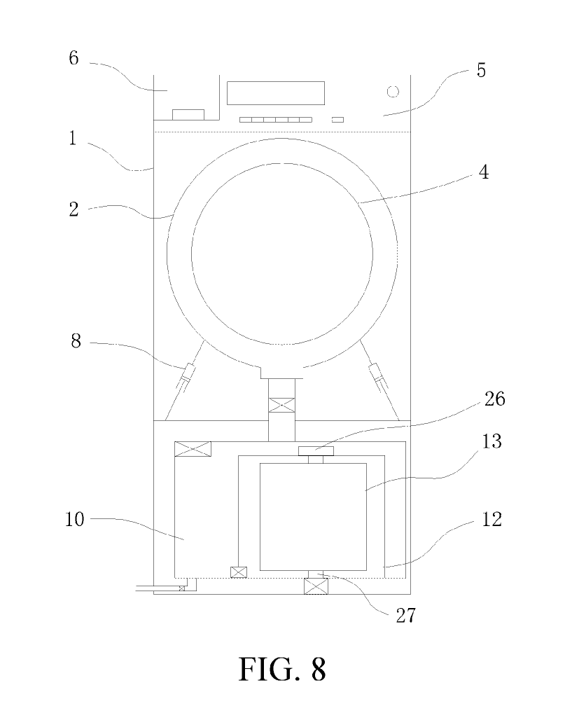

As shown in FIGS. 7 and 8, this embodiment makes further improvement on the basis of the above embodiment: the strainer 13 is a tubular structure and rotatably disposed in the filter container 12, one end is driven and connected through a cleaning motor 26, and the other drains the filtered water into the outer drum 2 through a rotating joint 27.

### Embodiment 6

A control method of the washing machine of the present invention is: after washing ends, water is drained to the circulated water treatment device, passes through the flocculation treatment unit for flocculation treatment and the filter unit for filtering in sequence, and then is drained into the outer drum 2 for rinsing, the water treatment process is circulated until the rinsing ends, and the water is drained into the circulated water treatment device to be cleaned through the flocculation treatment unit and the filter unit and is finally drained out. Specifically, the method is described as follows.

### Washing:

After selection of a required washing procedure and a flocculation treatment function, a start button is pressed down, water floods in the washing machine to a set intake amount, the motor drives the inner drum to rotate, and the washing starts.

### Flocculation:

After the washing ends, the outlet control valve is opened, to drain dirty wash water into the flocculation container. A main control panel adds a certain amount of flocculate into the flocculation container through a flocculant dispenser according to a set program, after standing for a period of time, the flocculate will condense dirt in the flocculation container into large particles to float in the container, and the bottom is treated clean water.

### Filter:

After the flocculation ends, the stop valve/on-off control structure is opened, the clean water in the flocculation container will enter into the filter container, the strainer in the filter container will block the flocculate and the dirt outside the strainer, and the clean water will be driven by the circulating pump at the bottom into the outer drum 2 again to continue the rinsing.

### Circulation:

The flocculation and filter processes are repeated once to three times, and stop until a turbidity sensor detects that the wash water in the outer drum 2 has become clean. Alternatively, according to experimental data, a fixed number of times of circulation can also achieve a better effect.

### Cleaning and Drainage:

After circulated treatment of water ends, the water in the outer drum 2 is drained into the flocculation container once again, at the same time, the stop valve/on-off control structure is opened to make some water flood into the filter container to clean the strainer, and finally the drain valve is opened to drain flocculated sewage, sewage on the strainer, threads and water outside the washing machine.

### Embodiment 7

According to the present invention, whether flocculation treatment is required is judged according to the turbidity degree of the wash water detected after washing, when the turbidity degree is higher, the wash water can be directly drained out completely, clean water floods in again for rinsing, and after first rinsing, flocculation circulation rinsing is carried out with water; or a certain proportion of wash water is drained out according to the range of the turbidity degree, then tap water floods in to reduce the turbidity degree, and flocculation circulation rinsing is carried out with water.

The washing machine of the present invention further includes an automatic detergent dispensing device, the automatic detergent dispensing device is the existing technology, preferably a structure that pumps and dispenses detergent by using intake negative pressure; the flocculant dispenser of the present invention is an automatic dispensing structure, and according to wash water quantity and the turbidity degree of wash/rinse water, a corresponding proportion of flocculant is automatically dispensed during each flocculation treatment; preferably, the flocculant is flaky, and it is feasible to employ an automatic dispensing structure of the existing flaky flocculant.

The implementation solutions in the above embodiments can be further combined or replaced, and the embodiments merely describe preferred embodiments of the present invention, instead of limiting the concept and the scope of the present invention; without departing from the design concept of the present invention, various variations and improvements made to the technical solutions of the present invention by persons skilled in the art all belong to the protection scope of the present invention.

What is claimed is:

1. A washing machine having a circulated water treatment function, comprising:
a water containing drum, a washing structure disposed in the water containing drum and a circulated water treatment device disposed below the water containing drum,
wherein the circulated water treatment device comprises a flocculation treatment unit and a filter unit;
wherein the flocculation treatment unit comprises a flocculation container in communication with the water containing drum and a flocculant dispenser to which a flocculant is dispensed into the flocculation container, and the water containing drum drains water into the flocculation container for flocculation treatment; and
wherein the filter unit comprises a filter container and a strainer disposed in the filter container, the filter container is in communication with the flocculation container and the water containing drum respectively, and the water after flocculation treatment in the flocculation container is filtered and then re-drained into the water containing drum for reuse.

2. The washing machine having the circulated water treatment function according to claim 1, wherein the circulated water treatment device further comprises a circulated water structure that drains the water after flocculation and filtering into the water containing drum for recycling, and a drainage structure that drains the water outside the washing machine at the end of work.

3. The washing machine having the circulated water treatment function according to claim 1, wherein a lower portion of the flocculation container and a lower portion of the filter container control connection/disconnection between the two containers through an on-off control structure, an upper portion of the flocculation container is in communication with a water outlet at the bottom of the water containing drum through a water guide pipe, and the water guide pipe is provided with an outlet control valve.

4. The washing machine having the circulated water treatment function according to claim 3, wherein the bottom of the flocculation container is provided with a drainage structure that drains water outside the washing machine, comprising a flocculation container drain outlet, a drain pipe and a drain valve in communication with the drain outlet.

5. The washing machine having the circulated water treatment function according to claim 3, wherein the filter container is provided with a circulated water structure that drains filtered water into the water containing drum, comprising a filter container circulated water outlet, a circulating pump and a circulating pipe, the circulating pipe is in communication with the water containing drum, the strainer divides the interior of the filter container into two parts, the first part is in communication with the flocculation container, and the second part is in communication with the water containing drum through the circulated water structure.

6. The washing machine having the circulated water treatment function according to claim 1, wherein the flocculation container is disposed above the filter container, the bottom of the flocculation container is in communication with the upper portion of the filter container through a connecting pipe, the connecting pipe is provided with a stop valve, the upper portion of the flocculation container is in communication with a water outlet at the bottom of the water containing drum through a water guide pipe, and the water guide pipe is provided with an outlet control valve.

7. The washing machine having the circulated water treatment function according to claim 6, wherein the bottom of the filter container is provided with a drainage structure that drains water outside the washing machine and a circulated water structure that drains filtered water into the water containing drum, the strainer divides the interior of the filter container into two parts, the first part is in communication with the connecting pipe and the drainage structure respectively, and the second part is in communication with the water containing drum through the circulated water structure.

8. The washing machine having the circulated water treatment function according to claim 1, wherein the flocculation treatment unit further comprises a flocculation stirring structure that mainly consists of a stirring motor, a stirring shaft and a stirring impeller, the stirring motor is disposed outside the flocculation container, the stirring shaft extends to the interior of the flocculation container from the stirring motor, and the stirring impeller is disposed on the stirring shaft inside the flocculation container.

9. The washing machine having the circulated water treatment function according to claim 1, wherein the strainer is a tubular structure and rotatably disposed in the filter container, one end is driven and connected through a cleaning motor, and the other drains the filtered water into the water containing drum through a rotating joint.

10. A control method of the washing machine according to claim 1, wherein, after washing ends, water is drained to the circulated water treatment device, passes through the flocculation treatment unit for flocculation treatment and the filter unit for filtering in sequence, and then is drained into the water containing drum for rinsing, the water treatment process is circulated until the rinsing ends, and the water is drained into the circulated water treatment device to be cleaned through the flocculation treatment unit and the filter unit and is finally drained out.
